(19) United States
(12) Patent Application Publication
(10) Pub. No.: US 2004/0265487 A1
(43) Pub. Date: Dec. 30, 2004

(54) Roller coating

(76) Inventors: Roger H. Calendine, Pittsford, NY (US); Rick J. Kosakowski, Rochester, NY (US); Gordon W. Redshaw, Rochester, NY (US); Dennis R. Fronheiser, Rochester, NY (US); Douglas E. Garman, Webster, NY (US)

Correspondence Address: F. Lindsey Scott, Suite B, 2329 Coit Road, Plano, TX, 75075, US

(21) Appl. No.: 10/608,282

(22) Filed: Jun. 27, 2003

(51) Int. Cl. B05D 5/04

(52) U.S. Cl. 427/177; 427/428.01; 427/428.18; 427/444

(57) ABSTRACT

A method for applying a seamless coating of a surface-modifying material to a product roller by transfer of the material to the product roller, from an application roller, to produce the seamless coating. Gravure rollers, slot dies, falling curtains or ribbons, jets and sprays may be used to deposit the material on the product roller. Dipping may also be used. Gravure rollers are preferred as the application roller. The coating is applied as a plurality of coatings, which are applied without drying the previous coating before application of a subsequent coating.

### FIELD OF THE INVENTION

This invention relates to the application of a seamless coating of a surface-modifying material to a roller.

### BACKGROUND OF THE INVENTION

In electrophotographic processes, rollers are used in various applications. In particular they are used for a pressure/temperature treatment of a toner image on a substrate. The toner image is fixed by the pressure/temperature treatment to the substrate, which is usually paper, by passage between two rollers. One of the rollers is typically referred to as fuser roller, with the other being referred to as a pressure roller. The surfaces of at least one of the rollers may be coated with silicone rubber, rubber, or other materials which may have different surface characteristics than those desired for the application for which the roller is intended.

A variety of processes have been used in attempts to cover such rollers with surface-modifying materials. Such processes have been used in areas other than electrophotographic processing. Processes such as dip coating and ring coating have been used. Applicant is unaware of the use of these techniques to produce coated rollers for electrophotographic processes.

Typically, fuser rollers are coated with a material such as a silicone rubber to provide a roller surface of a given hardness which may be overcoated with a low surface energy material to provide desired release properties which are not achievable with silicone rubber alone. These properties, in many instances, are determined as a part of the design of the hardware and the optimization of the equipment. When it is desired to apply a surface-modifying material to the outer surface of these rollers, it is essential that the material be deposited in a required thickness as a seamless coating.

Accordingly, a continuing search has been directed to the development of methods for providing a seamless coating of a surface-modifying material on roller surfaces, especially for electrophotographic process requirements.

### SUMMARY OF THE INVENTION

According to the present invention, seamless coatings of surface-modifying materials are readily applied to an outer surface of a product roller by applying a mixture containing the surface-modifying material to a rotatable gravure roller; rotating the product roller; rotating the gravure roller in mixture-transferring contact with the product roller to transfer the mixture to the product roller; and, continuing application of the surface-modifying material to the gravure roller and continuing rotation of the product roller until a selected quantity of surface-modifying material has been transferred to the outer surface of the product roller.

The invention further comprises a method for coating an outer surface of a product roller with a seamless coating of a surface-modifying material by positioning the product roller in surface-modifying material transfer contact with an application roller having a central axis and an outer surface and rotating the product roller and the application roller; positioning a metering roller having an outer surface and a central axis above and horizontally displaced from the central axis of the application roller so that a reservoir of a mixture containing the surface-modifying reservoir space is positioned between the metering roller and the application roller and so that a selected spacing is present between the outer surface of the metering roller and the outer surface of the application roller; rotating the metering roller in an opposite direction to the rotation of the application roller to position a selected quantity of the mixture containing the surface-modifying material on the outer surface of the application roller so that at least a portion of the quantity of the mixture containing the of surface-modifying material is transferred to the product roller; and, continuing the transfer of surface modifying-material to the product roller until a selected amount of the mixture containing surface-modifying material has been transferred to the outer surface of the product roller as a seamless coating.

The present invention further comprises a method for applying a seamless coating of a surface-modifying material to an outer surface of a product roller by a method comprising rotating the product roller; applying a mixture containing the surface-modifying material to the outer surface of the product roller at a controlled rate; and, continuing application of the mixture until a selected quantity of the surface modifying material has been deposited as a seamless coating on the outer surface of the product roller. The mixture may be applied to the outer surface of the product roller by a slot die, by use of a falling curtain (or a ribbon) of the mixture onto the product roller, impinging a jet of the mixture onto the product roller, or by the use of a spray.

The invention further comprises a method for coating an outer surface of a product roller for an electrophotographic process with a seamless coating of a surface-modifying material, the method comprising: providing a mixture containing the surface-modifying material; immersing the outer surface of the product roller in the mixture; and, withdrawing the product roller from the mixture at a controlled rate.

### BRIEF DESCRIPTION OF THE DRAWINGS

FIG. 1 is a schematic diagram of an embodiment of the process of the present invention using a gravure roller;

FIG. 2 is a schematic diagram of the embodiment of the process of the present invention, using a gravure roller and an intermediate roller to deposit a coating of a surface-modifying material on a product roller;

FIG. 3 is an embodiment of the process of the present invention wherein a reverse metering roller is used in connection with an application roller to deposit a seamless coating of a surface-modifying material on a product roller;

FIG. 4 is a schematic diagram of an embodiment of the process of the present invention wherein a mixture containing a surface-modifying material is positioned on a rotating product roller with a slot die;

FIG. 5 is a schematic diagram of an embodiment of the process of the present invention wherein a mixture containing a surface-modifying material is applied to the surface of a product roller by use of a falling curtain process;

FIG. 6 is a schematic diagram of an embodiment of the process of the present invention wherein a spray coating process is used;

FIG. 7 shows a product roller suitable for coating by the process of the present invention; and,

FIG. 8 is a schematic diagram of an embodiment of the process of the present invention wherein the product roller is coated by immersion in a mixture containing a surface-modifying material.

### DESCRIPTION OF THE PREFERRED EMBODIMENTS

In the description of the Figures, the same numbers will be used throughout to refer to the same or similar components.

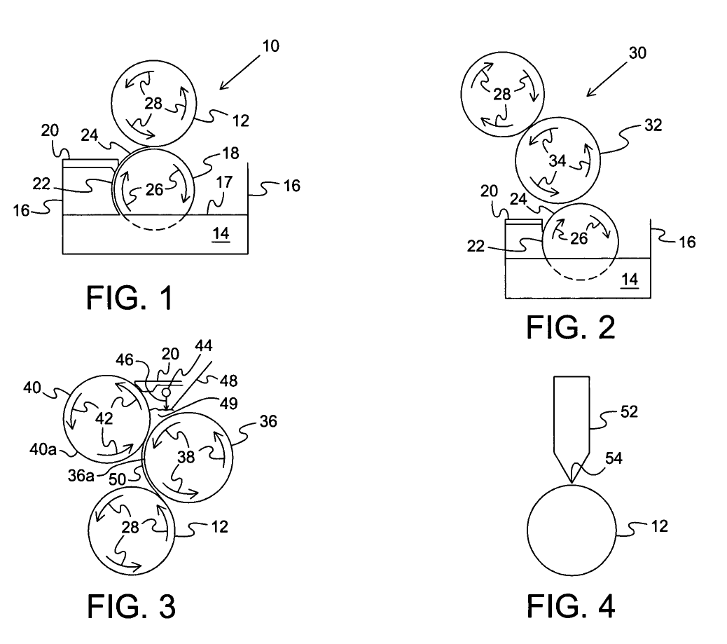

In FIG. 1, a gravure roller is used to deposit a seamless coating of a surface-modifying material on a product roller.

Gravure rollers have been used previously to coat continuous strips of material or to transfer images to substrates and the like. Gravure rollers are not considered to have been used to deposit coatings of a substantial thickness on surfaces and especially not on cylindrical surfaces. Gravure rollers are rollers having a textured outer surface so that the textured outer surface facilitates transfer of a fluid from the outside of the gravure roller to a surface contacted by the textured outside of the gravure roller.

In FIG. 1, a gravure process 10 is shown. In the process shown, a product roller 12 is coated with a suitable mixture containing a surface-modifying material, which is supplied as a liquid consisting of a mixture of the surface-modifying material and a suitable solvent. The mixture of solvent and surface-modifying material is adjusted to a consistency suitable for use with a gravure roller and consistent with the deposit requirements on product roller 12. The mixture is contained in a container 16 and a gravure roller 18 is positioned to contact the mixture, which is maintained in container 16 at a level 17. A doctor blade 20 is positioned to remove excess mixture from gravure roller 18 as it rotates. An excess layer is shown at 22 with a layer of the desired thickness after treatment by the doctor blade being shown at 24. Arrows 26 indicate the direction of rotation of gravure roller 18 with arrows 28 indicating the direction of rotation of the product roller. It will be understood that the direction could be reversed by simply moving the doctor blade as necessary.

The process is conducted by rotation of the two rollers as shown, with the process being continued until a seamless coating of the surface-modifying material is deposited on product roller 12. The process is continuous and it does not require that the solvent be evaporated fully from the surface-modifying material on product roller 12 before depositing subsequent layers. The use of the rotary process ensures the deposit of a seamless coating of the surface-modifying material on product roller 12 of a desired thickness. Typically, the thickness selected is from about 5 to 10 microns up to about 300 microns. While thinner or thicker coatings could be used, it is considered that this range will be suitable for most applications. Clearly, the application of thicker layers requires a longer contacting time and the use of thinner layers can be accomplished with reduced time. The time required typically varies from about 20 seconds to about 20 minutes, dependent upon the concentration of the surface-modifying material in the mixture, roller size, desired thickness and the like.

Different surface-modifying materials may be coated on a product roller by positioning the product roller in a different coating apparatus of any type disclosed herein or known to the art for such coating and applying a coat of a second surface modifying material over a first surface-modifying material. In a similar fashion, separate apparatus could be used for a more rapid initial coating of a surface-modifying material with a slower application of a second coat of the same or a second material of a surface-modifying material.

The present method can be characterized as a wet-on-wt coating method. the product roller after the initial contact with an applicator roller, slot die deposit, a falling curtain or ribbon, a jet or a spray of the mixture is only partly, if even significantly dried, before the before deposit of the next layer as the product roller is rotated. It has been found that drying between contacts and additional deposits is unnecessary in the deposit of seamless coatings of a desired thickness on the product roller.

While the present invention has been shown as a coating method for rollers, it should be understood that the method of the present invention is equally useful to coat fuser belts and the like.

In FIG. 2, a variation of the process of FIG. 1 is presented. In FIG. 2, the gravure roller transfers the mixture to an intermediate roller 32, which rotates in a direction as shown by arrows 34 to transfer the mixture to product roller 12. Rotation of gravure roller 18 and product roller 12 is shown by arrows 26 and 28. In this process, the rollers may be considered to be in contact with each other, but in fact are maintained at a spacing such that the mixture is deposited from roller to roller as discussed. Similarly, in FIG. 1, the rollers are spaced at a contact spacing such that the mixture on gravure roller 18 is at least partially transferred to product roller 12.

In FIG. 3, a further variation of the method of the present invention is shown. A product roller 12 is shown and is rotated as shown by arrows 28. An application roller 36 is shown which rotates in a direction shown by arrows 38. A layer 36a of the mixture is conveyed by application roller 36 to product roller 12. A metering roller 40 is positioned at a spacing from application roller 36 to result in the production of a layer 50 of the mixture on outer surface 36a of application roller 36 sufficient to convey the mixture to an outer surface of product roller 12. Metering roller 40 rotates in an opposite direction to application roller 36 thereby maintaining the contact spacing between the two rollers. A reservoir space 49 is provided and is shown filled with the mixture. This mixture is supplied through a line 44, which as indicated discharges the mixture into the reservoir area as shown by arrow 46. A sensor 48, which may be a temperature sensor or other property sensor of the mixture, is positioned to maintain a level of mixture in reservoir space 49 such that the mixture is maintained in a quantity sufficient to result in a continuous feed of the mixture between rollers 36 and 40 to deposit the mixture on product roller 12. A doctor blade 20 is shown positioned to prevent the movement of a substantial amount of the mixture along outer surface 40a of roller 40.

In FIG. 4, a method is shown for coating product roller 12 with a mixture containing a surface-modifying material by ejecting the mixture from a fluid reservoir 52 via a slot die 54 onto product roller 12 as it is rotated. This results in the production of a seamless coating of the surface-modifying material on product roller 12. The application is continued to produce a coating of a desired thickness.

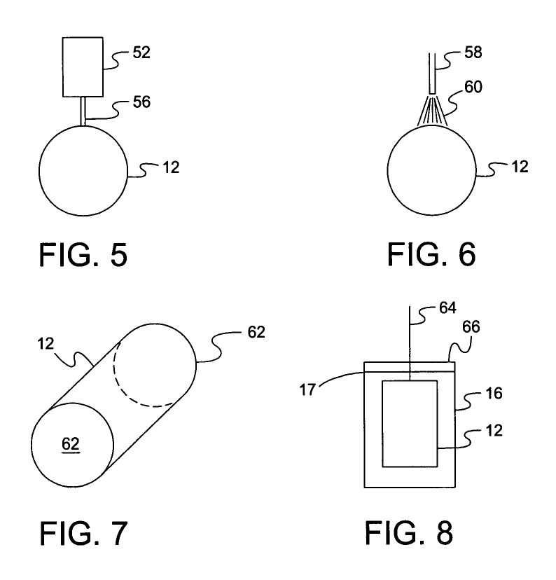

In FIG. 5, a fluid reservoir 52 is used with a slot for producing a falling curtain of mixture so that the mixture is coated onto the outside of product roller 12 as it rotates by a falling curtain or ribbon coating process.

FIG. 6 shows a further embodiment wherein a supply line 58 is used to supply the mixture to a spray 60 which coats product roller 12 as it rotates. Spray 60 may be a jet that ejects a fan-shaped spray with its width orthogonal to a long axis of the product roller with the jet being moved along the long axis of the product roller. Spray 60 may also be a fixed location spray that sprays continuously along the length (long axis) of the product roller.

In a still further embodiment of the process of the present invention, a roller 67 is shown in FIG. 7 for use in conjunction with FIG. 8. The product roller 12 comprises a roller having ends 62, which are desirably capped before treatment as shown in FIG. 8. In FIG. 8, product roller 12 is shown immersed in the mixture, which is present in container 16 to a level 17. Product roller 12 is supported by support 64 and is immersed in the mixture in container 16 at a level 17 beneath a top 66 of container 16 and either with or without rotation is withdrawn at a fixed rate to deposit a seamless coating of the surface-modifying material on the outer surface of roller 16. Desirably, ends 62 are capped so that the coating is applied only to the outer surface of product roller 12. Repeated applications of the dipping process may be made to achieve a desired thickness of the seamless coating on the outer surface of product roller 12.

In all the embodiments discussed, the process may be continued until a desired thickness of coating has been achieved on product roller 12. It is not necessary that the roller be dried between applications since the applications are continuously applied as the roller rotates. It has been found that the solvent is evaporated at a suitable rate and does not have to be fully removed from the surface-modifying material prior to application of a second layer.

As indicated previously, thicknesses from about 5 to about 300 microns are readily achieved, with coatings from about 25 to about 100 microns being used more typically. Further, in all the embodiments discussed, it is desirable that there be relative motion between the product roller and the applicator during application. Typically, the product roller is rotated at a rate from about 20 to about 100 rpms. The rollers contemplated for treatment by process of the present invention typically vary from about 1 to about 7 inches in diameter.

The rollers most desirably treated by the present invention are rollers for use in electrophotographic processes. Such rollers may be used for a variety of purposes but typically the rollers most commonly coated by the process of the present invention are used in fusing subsystems. Fuser rollers typically have an exterior coating of silicone rubber or the like. For a variety of process reasons, it may be desirable to increase or decrease the surface energy of the exterior of the product roller. Such variations are readily achieved by depositing a surface-modifying material on the outer surface of the product roller. While such coatings are particularly useful on fuser rollers or other rollers having silicone rubber exteriors or the like, a variety of other such rollers can also be coated by the process of the present invention. For instance, it may be desirable to coat fuser rollers, oiler rollers, primary charger rollers, transfer rollers, intermediate transfer rollers, paper or other substrate handling rollers and other rollers for electrophotographic processes with surface-modifying materials and the like.

Materials typically used to supply modified properties are materials such as TEFLON and VITON, both trademarks of Dupont Corporation. A number of polymers are encompassed within the trademarks discussed above. Some such polymers are presently tetrafluoroethylene, fluorinated ethylene-propylene resins, polymers of chlorofluoro-ethylene, polyvinylidene fluoride, hexafluoropropylene, co-polymers of vinylidene fluoride and hexafluoropropylene. Surface-modifying materials for coating rollers are known. Some suitable materials are disclosed in U.S. Pat. No. 4,430,406 issued Feb. 7, 1984 to James S. Newkirk, et al; U.S. Pat. No. 4,375,505 issued Mar. 1, 1983 to James S. Newkirk; U.S. Pat. No. 5,464,698 issued Nov. 7, 1995 to Jiann H. Chen, et al; U.S. Pat. No. 5,534,347 issued Jul. 9, 1996 to Tsang J. Chen, et al; U.S. Pat. No. 5,547,759 issued Aug. 20, 1996 to Jiann-Hsing Chen, et al; U.S. Pat. No. 5,582,917 issued Dec. 10, 1996 to Jiann H. Chen, et al; U.S. Pat. No. 5,595,823 issued Jan. 21, 1997 to Jiann H. Chen, et al; U.S. Pat. No. 5,599,631 issued Feb. 4, 1997 to Jiann-H. Chen, et al; U.S. Pat. No. 5,906,881 issued May 25, 1999 to Jiann H. Chen, et al; U.S. Pat. No. 6,355,352 B1 issued Mar. 12, 2002 to Jiann H. Chen, et al; U.S. Pat. No. 6,361,829 B1 issued Mar. 26, 2002 to Jiann H. Chen, et al; U.S. Pat. No. 6,372,833 B1 to Jiann H. Chen, et al; and, U.S. Pat. No. 6,383,699 B1 issued May 7, 2002 to Huoy-Jen Yuh, et al, all of which are hereby incorporated by reference.

Certain of these materials, typically considered as fluoropolymers provide polymeric surfaces having low surface energy. Others are viewed as fluoroelastomers and not only provide surfaces having reduced surface energy, but also provide relatively flexible surfaces. The properties of such materials are well known to those skilled in the art. Such materials may readily be used as dispersions or mixtures of these materials or similar materials in volatile solvents, such as ketones, blends of ethers with ketones, perfluorinated solvents and the like having a boiling point at standard atmospheric pressure from about 50 to about 160° C. In some instances, the polymers may be available in water-dispensable form (emulsions). Such emulsions typically comprise the polymeric materials in a blend with water, organic dispersing agents, dispersants or the like as known to the art. All such dispersions, solutions, emulsions and the like are referred to herein as “mixtures.” Mixtures of the materials are produced and used as discussed in the discussion of the Figures above to provide surface coatings for product rollers.

Attention should be given to the covering of the product roller prior by application of the mixture containing surface-property modifying material to be sure that the solvent does not damage or degrade the outside of product roller 12. Such considerations are well known to those skilled in the art.

Of the embodiments shown, the methods discussed in FIGS. 1 and 2 are preferred and of these, the embodiment shown in FIG. 1 is preferred.

The product roller may be of any suitable configuration and typically will include means for providing a central support for rotation of the roller at the end of the roller. The roller may be hollow or solid, although more typically hollow rollers are used. The configuration of the cylindrical roller is not critical to the practice of the present invention. Further, the direction of rotation of the rollers may be changed as desired. For instance, in FIG. 1, the rotation of the rollers can be reversed, in FIG. 2 the rotation of the roller can be reversed, and in FIGS. 4, 5 and 6 the rollers can be rotated in either direction. Similarly, in FIG. 8 if the product roller is rotated, it can be rotated in either direction. In FIG. 3, however, the metering roller requires repositioning if the direction of the rotation is reversed. Such variations are well known to those skilled in the art based upon a review of the descriptions above.

The use of the slot die shown schematically in FIG. 4, is readily operated by those skilled in the art by the use of pressure to eject the mixture from fluid reservoir 52 at a controlled rate along the length of the slot die extending along an outer surface of product roller 12. Similarly, the curtain or ribbon 56 of material dropping from fluid reservoir 52, as shown in FIG. 5, is readily maintained at a desired rate by those skilled in the art. The use of a spray or jet as shown in FIG. 6 is also readily regulated by those skilled in the art.

Desirably, the concentration of the surface-modifying material in the mixture is varied dependent upon the solubility or dispersibility of the surface-modifying material, the desired concentration of material for optimum formation of the seamless coating on product roller 12 and the like. Desirably, the mixture is formed to have a suitable consistency, i.e., viscosity, surface-modifying material content, drying rate and the like. Such variations are known to those skilled in the art and need not be discussed in any detail.

As indicated previously, desirably the product rollers coated are product rollers for use in electrophotographic processes. Not only are such rollers required in such processes with relatively specifically defined properties, but it is also necessary that the roller be produced reproducibly with seamless coatings of material on their exterior. Such rollers are ideally produced by the method of the present invention.

While the present invention has been described by reference to certain of its preferred embodiments, it is pointed out that the -embodiments described are illustrative rather than limiting in nature and that many variations and modifications are possible within the scope of the present invention. Many such variations and modifications may be considered obvious and desirable by those skilled in the art based upon a review of the foregoing description of preferred embodiments.

Having thus described the invention, we claim:

1. A method for coating an outer surface of a product roller for an electrophotographic process with a seamless coating of a surface-modifying material, the method comprising:
a) applying a mixture containing the surface-modifying material to a rotatable gravure roller;
b) rotating the product roller; and,
c) rotating the gravure roller in mixture-transferring contact with the product roller transferring at least a portion of the mixture to the product roller.

2. The method of claim 1 wherein transfer of the mixture to the product roller is continued by continuing application of the surface-modifying material to the gravure roller and continuing rotation of the product roller until a selected quantity of surface-modifying material has been transferred to the outer surface of the product roller.

3. The method of claim 1 wherein the mixture of the surface modifying-material is a mixture or dispersion of the surface-modifying material in a volatile solvent.

4. The method of claim 2 wherein the surface-modifying material is selected from the group consisting of tetrafluoroethylene, fluorinated ethylene-propylene resins, polymers of chlorofluoro-ethylene, polyvinylidene fluoride, hexafluoropropylene, co-polymers of vinylidene fluoride and hexafluoropropylene.

5. The method of claim 3 wherein the volatile solvent is a ketone having a boiling point at standard atmospheric pressure from about 50 to about 160° C.

6. The method of claim 1 wherein the mixture contains water or a blend of water with organic solvents and the surface-modifying material.

7. The method of claim 1 wherein the mixture is applied to the gravure roller by immersing a portion of the gravure roller in the mixture.

8. The method of claim 1 wherein the mixture is applied to the gravure roller by spraying the mixture onto the gravure roller.

9. The method of claim 1 wherein the product roller is a fuser roller, pressure roller, oil donor roller, intermediate transfer roller, primary charge roller, or a paper or other substrate handling roller.

10. The method of claim 1 wherein the gravure roller is in mixture-transferring contact with the product roller by mixture-transferring contact with an intermediate roller with the intermediate roller being in mixture-transferring contact with the product roller.

11. A method for coating an outer surface of a product roller for an electrophotographic process with a seamless coating of a surface-modifying material, the method comprising:
a) positioning the product roller in surface-modifying material transfer contact with an application roller having a central axis and an outer surface and rotating the product roller and the application roller;
b) positioning a metering roller having a central axis and an outer surface and a central axis above and horizontally displaced from the central axis of the application roller so that a mixture containing the surface-modifying reservoir space is formed between the metering roller and the application roller and so that a selected spacing is present between the outer surface of the metering roller and the outer surface of the application roller; and,
c) rotating the metering roller in an opposite direction to the rotation of the application roller to position a selected quantity of the mixture containing the surface-modifying material on the outer surface of the application roller so that at least a portion of the quantity of the mixture containing surface-modifying material is transferred to the product roller.

12. The method of claim 11 wherein transfer of the mixture to the product roller is continued by continuing application of the surface-modifying material to the gravure roller and continuing rotation of the product roller until a selected quantity of surface-modifying material has been transferred to the outer surface of the product roller.

13. The method of claim 11 wherein the mixture containing the surface modifying-material is a mixture or dispersion of the surface-modifying material in a volatile solvent.

14. The method of claim 12 wherein the surface-modifying material is selected from the group consisting of tetrafluoroethylene, fluorinated ethylene-propylene resins, polymers of chlorofluoro-ethylene, polyvinylidene fluoride, hexafluoropropylene, co-polymers of vinylidene fluoride and hexafluoropropylene.

15. The method of claim 13 wherein the solvent is a ketone having a boiling point at standard atmospheric pressure from about 50 to about 160° C.

16. The method of claim 11 wherein the mixture contains water or a blend of water with organic solvents and the surface-modifying material.

17. A method for coating an outer surface of a product roller for an electrophotographic process with a seamless coating of a surface-modifying material, the method comprising:
a) rotating the product roller; and,
b) applying a mixture containing the surface-modifying material to the outer surface of the product roller at a controlled rate.

18. The method of claim 17 wherein transfer of the mixture to the product roller is continued by continuing application of the surface-modifying material to the gravure roller and continuing rotation of the product roller until a selected quantity of surface-modifying material has been transferred to the outer surface of the product roller.

19. The method of claim 17 wherein the mixture of the surface modifying-material is a mixture or dispersion of the surface-modifying material in a volatile solvent.

20. The method of claim 19 wherein the surface-modifying material is selected from the group consisting of tetrafluoroethylene, fluorinated ethylene-propylene, resins, polymers of chlorofluoro-ethylene, polyvinylidene fluoride, hexafluoropropylene, co-polymers of vinylidene fluoride and hexafluoropropylene.

21. The method of claim 19 wherein the solvent is a ketone having a boiling point at standard atmospheric pressure from 50 to about 160° C.

22. The method of claim 17 wherein the mixture contains water or a blend of water with organic solvents and the surface-modifying material.

23. The method of claim 17 wherein the mixture is ejected onto the outer surface of the product roller by using a slot die.

24. The method of claim 17 wherein the mixture is applied at a selected rate as a falling curtain or ribbon of the mixture onto the product roller.

25. The method of claim 17 wherein the mixture is applied to the product roller as a jet or as a spray.

26. A method for coating an outer surface of a product roller for an electrophotographic process with a seamless coating of a surface-modifying material, the method comprising:
a) providing a mixture containing the surface-modifying material;
b) immersing the outer surface of the product roller in the mixture; and,
c) withdrawing the product roller from the mixture at a controlled rate.

27. The method of claim 26 wherein the mixture containing the surface modifying-material is a mixture or dispersion of the surface-modifying material in a volatile solvent.

28. The method of claim 27 wherein the surface-modifying material is selected from the group consisting of tetrafluoroethylene, fluorinated ethylene-propylene resins, polymers of chlorofluoro-ethylene, polyvinylidene fluoride, hexafluoropropylene, co-polymers of vinylidene fluoride and hexafluoropropylene.

29. The method of claim 28 wherein the solvent is a ketone having a boiling point at standard atmospheric pressure from 50 to about 160° C.

30. The method of claim 26 wherein the concentration of the surface-modifying material in the mixture is adjusted to a concentration sufficient to provide a desired quantity of the surface-modifying material on the outer surface of the product roller upon withdrawing the product roller.

31. A method for coating a product roller for a electrophotographic process with a seamless coating of a surface-modifying material by a wet-on-wet method, the method comprising:
a) depositing a first coating of a mixture containing the surface-modifying materials on an exterior of the product roller; and,
b) depositing at least one subsequent coating of the mixture onto the exterior o the product roller prior to drying the first coating.
